(19) United States
(12) Patent Application Publication
(10) Pub. No.: US 2022/0056320 A1
(43) Pub. Date: Feb. 24, 2022

(54) RETROREFLECTIVE ARTICLES CONTAINING ADHESIVE COMPOSITIONS INCLUDING STYRENIC BLOCK CO-POLYMERS

(71) Applicant: 3M INNOVATIVE PROPERTIES COMPANY, St. Paul, MN (US)

(72) Inventors: Tien Yi T.H. Whiting, St. Paul, MN (US); Ying Xia, Woodbury, MN (US); Justin M. Bolton, Minneapolis, MN (US); Kui Chen-Ho, Woodbury, MN (US); Shri Niwas, Maple Grove, MN (US); Jonathan E. Janoski, Woodbury, MN (US); Anthony F, Schultz, Forest Lake, MN (US); Gregg A. Patnode, Woodbury, MN (US); Carla S. Thomas, Woodbury, MN (US); Duane D. Fansler, Dresser, WI (US)

(21) Appl. No.: 17/417,456

(22) PCT Filed: Dec. 23, 2019
(86) PCT No.: PCT/IB2019/061310

§ 371 Date: Jun. 23, 2021

Related U.S. Application Data
(60) Provisional application No. 62/785,344, filed on Dec. 27, 2018.

(51) Int. Cl. C09J 7/38; G02B 5/128; C09J 11/06; C09J 7/20; B32B 5/02; B32B 7/12; A41D 13/01

(52) U.S. Cl. CPC C09J 7/387; B32B 2437/00; C09J 11/06; C09J 7/205; B32B 5/022; B32B 7/12; B32B 5/024; A41D 13/01; C09J 2203/358; C09J 2301/408; C09J 2301/414; C09J 2453/00; C09J 2400/266; B32B 2307/416; G02B 5/128

(57) ABSTRACT

There is provided retroreflective articles comprising a binder layer comprising an adhesive composition comprising at least one tackifier and at least one elastomer selected from at least one of natural rubbers and synthetic rubbers, and a layer of optical elements at least partially embedded in a major surface of the binder layer. There are also provided articles of clothing using the presently disclosed retroreflective articles and methods for preparing the retroreflective articles.

### FIELD

Disclosed herein are retroreflective articles, methods of preparing these retroreflective articles, and articles of clothing made using the retroreflective articles.

### BACKGROUND

Reflective materials or articles improve wearer conspicuity by returning incident light back toward a light source, which promotes safety for both occupational workers (e.g. traffic workers) and consumers (e.g. runners). Traditional binder materials for reflective materials involve either a solvent-based or a water-based coating chemistry, where the binder solution is coated on top of a mirrored bead coat substrate. The resulting coating is laminated either to a fabric to produce a fabric product, or to a transfer adhesive to make a transfer product. Improvements are needed in retroreflective materials or articles that are wash durable and have an average RA (coefficient of retroreflection in cd/lx/m²) of at least 100 after 50 wash cycles using ISO 6330 Method 6N test protocol.

### SUMMARY

The present disclosure provides retroreflective materials or articles made using these adhesive compositions are wash durable and have a minimum RA (coefficient of retroreflection in cd/lx/m²) of at least 100 after 50 wash cycles using ISO 6330 Method 6N test protocol. Also disclosed are articles that include at least one application layer; at least one binder layer; a layer of optical elements that are partially embedded in the at least one binder layer; and at least one reflective layer that is located functionally between the layer of optical elements and the binder layer, wherein the at least one binder layer, at least one application layer, or both comprise at least one of the presently disclosed adhesive compositions.

In one aspect, the present disclosure provides retroreflective articles comprising: a binder layer comprising an adhesive composition comprising at least one tackifier and at least one elastomer selected from at least one of natural rubbers and synthetic rubbers; and a layer of optical elements at least partially embedded in a major surface of the binder layer. In some embodiments, the at least one elastomer is a styrenic block copolymer. In some embodiments, the styrenic block copolymer comprises styrene end block and isoprene mid-block. In some embodiments, the styrenic block copolymer comprises diblock copolymers of a styrene block and an isoprene block.

In some embodiments, the at least one tackifier comprises non-carbon hetero-atom functionality. In some embodiments, the at least one tackifier has an acid number greater than or equal to 1 mg KOH/g. In some embodiments, the polarity index of the tackifiers is between 4 and 40. In some embodiments, the at least one tackifier comprises a carboxylic acid functional group.

In some embodiments, the at least one tackifier is derived from a maleic anhydride. In some embodiments, the at least one tackifier is derived from a non-reactive novolac phenolic compound. In some embodiments, the at least one tackifier is present in an amount of greater than or equal to 5 wt %, based on the total weigh of the adhesive composition.

In some embodiments, the at least one elastomer is present in an amount greater than or equal to 30 wt %, based on the total weight of the adhesive composition. In some embodiments, the adhesive composition further comprises a colorant or a filler.

In some embodiments, the retroreflective article is wash durable. In some embodiments, the presently disclosed retroreflective articles further comprise an application layer disposed on a major surface of the binder layer opposite the major surface in which the layer of optical elements is at least partially embedded. In some embodiments, the application layer comprises a layer of an adhesive, a film, a fabric, or a non-woven.

In another aspect, the present disclosure provides an article of clothing comprising: a substrate layer comprising a fabric, where the substrate layer has a first major surface and a second major surface; and a retroreflective applique disposed on the first major surface of the substrate layer, where the retroreflective applique comprises: a binder layer comprising an adhesive composition comprising at least one tackifier and at least one elastomer selected from at least one of nature rubbers and synthetic rubbers; and a layer of optical elements at least partially embedded in the binder layer. In some embodiments, the article of clothing further comprises an application layer attached to the binder layer, where the application layer comprises a layer of at least one of an adhesive, a film, a fabric, or a non-woven, and where the application layer is the layer in the retroreflective applique that is disposed on the first major surface of the fabric.

In yet another aspect, the present disclosure provides a method of preparing a retroreflective article comprising: (a) providing a binder layer comprising an adhesive composition, where the adhesive composition comprises (i) at least one elastomer selected from at least one of natural rubbers and synthetic rubbers; and (ii) at least one tackifier; and (b) disposing the binder layer on portions of protruding areas of at least some optical elements that are borne by a carrier layer, where the optical elements are at least partially embedded in the binder layer. In some embodiments, the presently disclosed method further comprises attaching an application layer to a major surface of the binder layer opposite the optical elements, where the application layer comprises at least one of an adhesive layer, a film layer, a fabric layer, or a non-woven layer, or combinations thereof.

The above summary of the present disclosure is not intended to describe each disclosed embodiment or every implementation of the present disclosure. The description that follows more particularly exemplifies illustrative embodiments. In several places throughout the application, guidance is provided through lists of examples; examples can be used in various combinations. In each instance, the recited list serves only as a representative group and should not be interpreted as an exclusive list.

### BRIEF DESCRIPTION OF THE DRAWINGS

FIG. 1 shows a cross-sectional view of an embodiment of an article of clothing including the presently disclosed adhesive compositions.

FIG. 2 shows a cross-sectional view of an embodiment of an intermediate article of this disclosure.

FIG. 3 shows a cross-sectional view of an embodiment of an intermediate article of this disclosure.

FIG. 4 shows a cross-sectional view of an embodiment of an article of this disclosure.

FIG. 5 shows a cross-sectional view of an embodiment of an article of this disclosure.

FIG. 6 shows a top view of an embodiment of an article of this disclosure.

FIG. 7 shows post-wash images of fabric to which various presently disclosed examples were adhered.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising” and the like.

As used herein, “consisting essentially of,” as it relates to a composition, apparatus, system, method or the like, means that the components of the composition, apparatus, system, method or the like are limited to the enumerated components and any other components that do not materially affect the basic and novel characteristic(s) of the composition, apparatus, system, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also, as used herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range.

Disclosed herein are retroreflective articles and methods of making and using them. In some embodiments, the retroreflective articles comprise a rubber elastomer binder layer, and a layer of optical elements partially embedded in the binder layer. In some embodiments, the retroreflective article comprises a binder layer, a layer of optical elements partially embedded in the binder layer, and an additional application layer. The optical elements comprise transparent microspheres and at least one reflective layer. Optionally, the optical elements comprise one or more polymeric intervening layer. Such an intervening layer may serve any desired function. In some embodiments it may serve as a physically-protective layer and/or a chemically-protective layer (e.g. that provides enhanced abrasion resistance, resistance to corrosion, etc.). In some embodiments such a layer may serve as a bonding layer (e.g. a tie layer or adhesion-promoting layer) that is capable of being bonded to by a reflective layer as discussed later herein. It will be appreciated that some intervening layers may serve more than one, e.g. all, of these purposes. In some embodiments, such an intervening layer may be transparent (specifically, it may be at least essentially free of any colorant or the like). Organic polymeric layers (e.g. protective layers) and potentially suitable compositions thereof are described in detail in U.S. Patent Application Publication No. 2017/0276844 (McCoy), which is incorporated by reference in its entirety herein. In particular embodiments, such a layer may be comprised of a polyurethane material. Various polyurethane materials that may be suitable for such purposes are described e.g. in U.S. Patent Application Publication No. 2017/0131444 (Ying), which is incorporated by reference in its entirety herein. In some embodiments, the at least one tackifier in the rubber elastomer binder layer further comprises non-carbon hetero-atom functionality. In some embodiments, the rubber elastomer binder layer comprises a styrenic block copolymer. In some embodiments, the additional application layer comprises a rubber elastomer. In some embodiments, the presently disclosed retroreflective articles are wash durable when applied to a substrate.

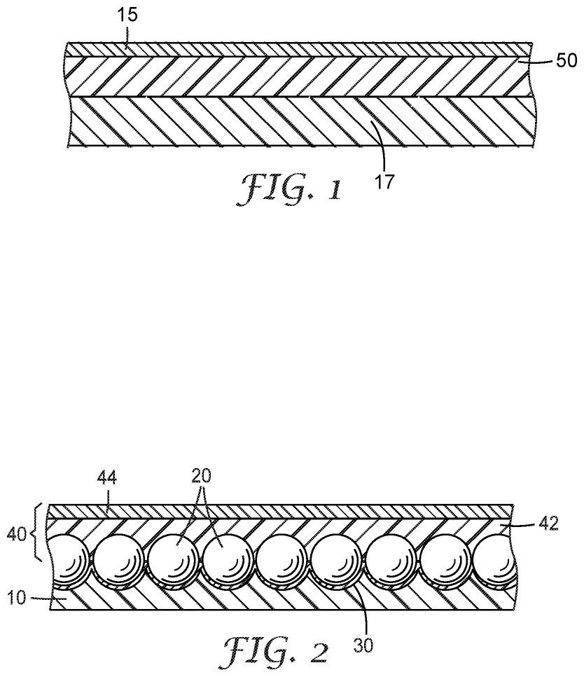

Also disclosed herein are articles of clothing. Referring to FIG. 1, in some embodiments, the articles of clothing include an adhesive composition (or application layer) 50 with a first major surface attached to a first laminating substrate 15 and a second major surface attached to a second laminating substrate 17. The first and the second laminating substrates 15, 17 can be a layer of another adhesive, a film layer, a fabric layer, or a non-woven layer. The first and the second laminating substrates 15, 17 can be the same or different materials. In some embodiments, the adhesive composition (or application layer) 50 between the first and the second laminating substrates 15, 17 comprises a rubber elastomer comprising a styrenic block copolymer and at least one tackifier with non-carbon hetero-atom functionality.

Also disclosed herein are articles of clothing. In some embodiments, the articles of clothing include a substrate layer (such as, a fabric) with a first major surface and a second major surface, and a retroreflective applique attached to the first major surface of the substrate layer, or fabric. The retroreflective applique comprises a binder layer comprising an adhesive composition, where the adhesive composition includes an elastomer selected from at least one of a synthetic rubber or a natural based rubber and at least one tackifier, a layer of optical elements at least partially embedded in the binder layer, and an application layer attached to the rubber elastomer binder layer. The retroreflective applique also includes a layer of optical elements at least partially embedded in the binder layer, where the optical elements include a layer of transparent microspheres disposed on at least one reflective layer. The retroreflective applique also includes an application layer attached to the binder layer, wherein the application layer comprises a layer of at least one of an adhesive, a film, a fabric, or a non-woven, and where the application layer is the layer in the retroreflective applique that is attached to the first major surface of the substrate layer, or fabric. In some embodiments, the at least one tackifier in the binder layer comprises non-carbon hetero-atom functionality. In some embodiments, the application layer comprises a layer of adhesive, a film layer, a fabric layer, or a non-woven layer, and the application layer is attached to the first major surface of the fabric. In some embodiments, the rubber elastomer application layer comprises at least one tackifier, further comprising non-carbon hetero-atom functionality.

Examples of articles of this disclosure are provided in the Figures. FIG. 2 is a cross sectional depiction of an embodiment of an intermediate article of this disclosure. In FIG. 2, the intermediate article includes binder layer 10, optical elements 20, reflective layer 30 and carrier layer 40. Carrier layer 40 includes sheet layer 44 and a coating of thermoplastic polymeric carrier material 42.

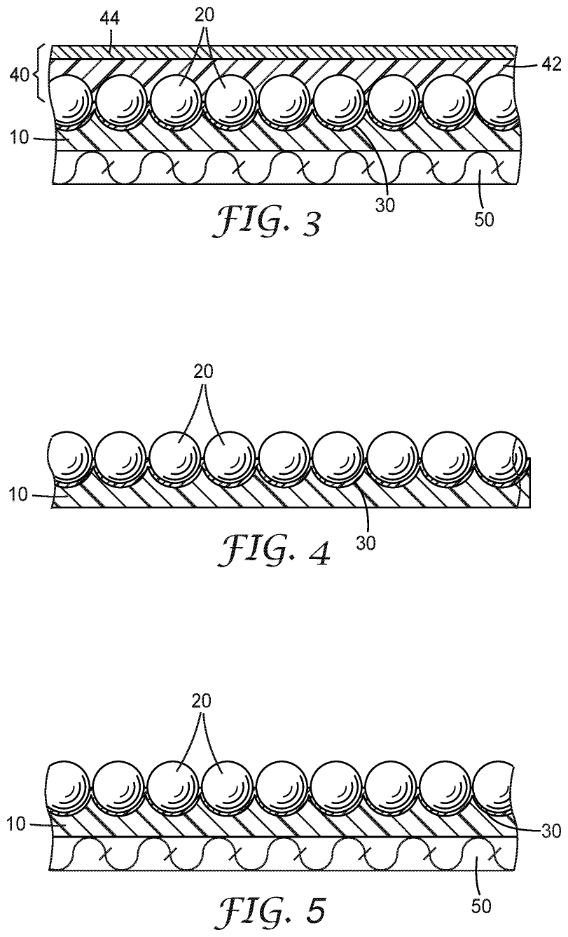

FIG. 3 depicts an alternative embodiment of an intermediate article of this disclosure. In FIG. 3, the intermediate article includes binder layer 10, optical elements 20, reflective layer 30 and application layer 50. Application layer 50 is disposed on a major surface of binder layer 10 opposite the major surface in which the layer of optical elements 20 is at least partially embedded. Application layer 50 could be or could include an adhesive, a fabric, a film, or a non-woven. In some embodiments, the application layer is a stretchable material. In some embodiments, the fabric is selected from at least one of cotton blends, polyester blends, nylon, and spandex.

FIG. 4 depicts the embodiment of FIG. 2 in which the carrier layer 40 has been removed. In FIG. 4, the article includes binder layer 10, transparent microspheres 20, and reflective layer 30.

FIG. 5 depicts the embodiment of FIG. 3 in which the carrier layer 40 has been removed. In FIG. 5, the article includes binder layer 10, transparent microspheres 20, reflective layer 30, and application layer 50. Application layer 50 could be or could include an adhesive, a fabric, a film, or a non-woven. In some embodiments, these layers are individually or collectively wash durable.

Also disclosed herein are articles of clothing that contain retroreflective appliques of the present disclosure. These articles of clothing comprise a fabric with a first major surface and a second major surface, and a retroreflective applique attached to the first major surface of the fabric. The retroreflective applique is the retroreflective article described above. A wide variety of fabrics are suitable. In some embodiments, the fabric is a stretchable material. In some embodiments, the fabric is selected from at least one of cotton blends, polyester blends, nylon, and spandex.

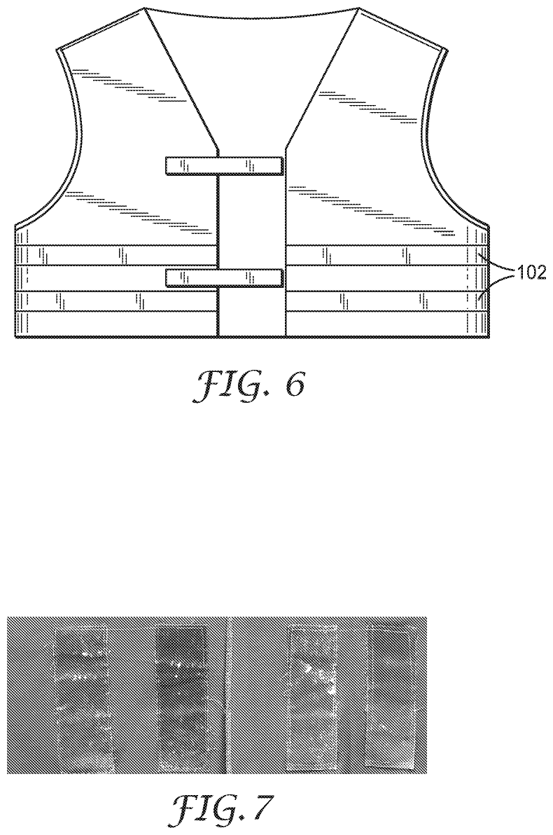

FIG. 6 depicts an article of clothing of the present disclosure. The vest in FIG. 6 includes retroreflective appliques 102. The retroreflective appliques 102 can be, for example, an article of FIG. 5.

Methods of preparing these retroreflective articles are also disclosed herein. In some embodiments, the method of preparing a retroreflective article comprises: providing a polymeric carrier layer with a first major surface and a second major surface; providing transparent microspheres; at least partially embedding the transparent microspheres into the first major surface of the polymeric carrier layer such that the beads at least partially protrude from the first major surface of the polymeric carrier layer to form a layer of microspheres; depositing one or more reflective layers on at least a portion of the first major surface of the polymeric carrier layer and the layer of microspheres; providing the rubber elastomer mixture containing at least one non-reactive tackifier, applying the rubber elastomer mixture to form a binder layer. The presently disclosed methods may also comprise attaching an application layer to the rubber elastomer binder layer, where the application layer may be an adhesive of a rubber elastomer mixture. Removal of the polymeric carrier layer generates a wash durable retroreflective article.

The presently disclosed retroreflective articles have a rubber elastomer binder layer or application layer that enhances the durability of the retroreflective article, especially the wash durability of the retroreflective article. The rubber elastomer binder layer is prepared from generating a mixture that contains at least one non-reactive tackifier. Since it is desirable that the presently disclosed retroreflective articles are washable, wash durability is particularly important. Wash durability as used herein means the number of times the retroreflective article can be laundered without losing its retroreflective performance.

Considerable effort has also been expended in modifying the binder layer to make it more wash durable, and thus to improve the wash durability of the retroreflective articles. Some of these attempts have included the use rubber elastomer. As used herein, the term “elastomer” refers to a polymer containing elastic properties, which gives the polymer the tendency to return to its original shape after being stretched or compressed. For example, U.S. Pat. No. 5,055,347 (Bacon) describes a retroreflective article with retroreflective elements embedded in an elastomeric support layer. The support layer is a reactive (vulcanizable) or curable elastomer thermoset, which forms a strong bond when cured.

As used herein the terms “thermoplastic”, “non-thermoplastic”, and “thermoset”, refer to properties of materials. The term “thermoplastic materials” as used herein means materials that melt or flow upon the application of heat, resolidify upon cooling and again melt or flow upon the application of heat. The thermoplastic material undergoes a physical change, such as a change in phase, rheology, or viscosity, only upon heating and cooling, however, no appreciable chemical change in the material occurs. The term “non-thermoplastic materials” as used herein means materials that do not melt or flow upon the application of heat up to a temperature where the material begins to degrade. The term “thermoset materials” as used herein means curable materials that irreversibly cure, such as becoming crosslinked, when heated or cured. Once cured, the thermoset material will not appreciably melt or flow upon application of heat.

In some embodiments of the present disclosure, the rubber elastomer binder layer is not a reactive mixture, e.g. to be vulcanized or cured, and is therefore referred to as a thermoplastic material rather than a thermoset material. In some embodiments, the presently disclosed rubber elastomer binder layer contains at least one tackifier. In some embodiments, the at least one tackifier contains polar (non-carbon) hetero-atom functionalities.

U.S. Pat. No. 6,110,558 (Billingsley) describes a retroreflective article comprising a binder layer that comprises a thermoplastic copolymer that comprises units containing carboxyl functionality. In some embodiments of U.S. Pat. No. 6,110,558 (Billingsley), the carboxyl functionality in the thermoplastic copolymer is selected from the group consisting of acrylic acid, methacrylic acid, itanoic acid, citraconic acid, maleic acid, fumaric acid, and combinations thereof.

In some embodiments of the present disclosure, the rubber elastomer is a thermoplastic copolymer that is substantially free of units of carboxyl functionality. The binder layer comprises at least one tackifier, which in some embodiments comprises non-carbon hetero-atom functionality. In some embodiments, the non-carbon hetero-atom functionality in the at least one tackifier contains carboxyl functionality.

In general, the tackifiers are compounds used in an adhesive composition to increase tack. The tackifiers are usually low molecular weight compounds with a high glass transition temperature, with characteristic molecular weight generally lower than approximately 10,000 grams per mole (g/mol). In contrast, polymeric compounds (such as ethylene acrylic acid copolymer, rubber polymer, and acrylic block copolymers) generally employed in adhesives have molecular weight on the order of 10,000 g/mol or higher. In some embodiments, the tackifier comprises non-carbon hetero-atom functionality. In some embodiments, the hetero-atom functionality in the tackifier contains units derived from non-reactive novalac phenolic compounds. In some embodiments, the hetero-atom functionality in the tackifier contains units derived from maleic anhydride. In some embodiments, the units derived from maleic anhydride are present on the thermoplastic copolymer as disclosed in U.S. Pat. No. 6,110,558 (Billingsley), which is incorporated herein by reference in its entirety.

Examples of types of adhesives are pressure sensitive adhesives, heat activated adhesives and laminating adhesives. Pressure sensitive adhesive compositions are known to those of ordinary skill in the art to possess properties including the following: (1) aggressive and permanent tack at room temperature, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process. The term “pressure sensitive adhesive” denotes a composition that obeys the Dahlquist criterion, which criterion will be well known and understood by the ordinary artisan working in the art of pressure-sensitive adhesives.

Heat activated adhesives are non-tacky at room temperature but become tacky and capable of bonding adherends at elevated temperatures. These adhesives usually have a glass transition temperature (Tg) or a melting point (Tm) above room temperature. When the temperature is elevated above the Tg or the Tm, the storage modulus usually decreases and the adhesive become tacky.

Laminating adhesives (also sometimes referred to as contact adhesives) are adhesives designed to be sandwiched between two substrates, or adherends, and form bonds with the substrates to form a three-layer laminate. The laminating adhesive can be a hot melt adhesive, pressure sensitive adhesive, curable (i.e. that can undergo a chemical reaction) adhesive, and mixture of adhesive pre-cursors that can be solidified by curing, cooling, drying, or other means to form the laminating adhesive. The laminating adhesive can be directly dispensed on one or both substrates, or coated between liners to form an adhesive pre-coat and subsequently laminated to one or both substrates. Examples of laminating hot melt adhesives include glue sticks used in hot glue guns (which are hot melt types of adhesives that form bonds upon cooling), casein glues, and “white glue” (which are water-borne dispersions that form bonds upon drying). Examples of curable adhesive include cyanoacrylate adhesives, which cure to form bonds upon exposure to air. Examples of adhesive pre-cursors include polymeric or oligomeric compounds such as epoxy, (meth)acrylic, polyurethanes, polysiloxanes, and polydienes.

As used herein, the term “adhesive” means polymeric compositions useful to adhere together adherends, which can be any of the above adhesives. In some embodiments of the present disclosure, the rubber elastomer binder layer or the rubber elastomer application layer comprises a laminating adhesive composition.

As used herein, the term “polymer” means a polymeric material that is a homopolymer or a copolymer. As used herein, the term “homopolymer” means a polymeric material that is the reaction product of one type of monomer. As used herein, the term “copolymer” refers to a polymeric material that is the reaction product of at least two different types of monomers.

In the present disclosure, the rubber elastomer binder layer, and optionally the application layer, includes at least one elastomer that is chosen from natural rubbers and synthetic rubbers and combinations thereof. A natural rubber (being comprised in large part of poly-cis-isoprene) is conventionally considered to be a “non-thermoplastic hydrocarbon elastomer” that may often exhibit no measurable melting temperature as measured using Differential Scanning calorimetry (DSC); accordingly, in some cases it may require special processing or compounding in order to be incorporated into an adhesive composition.

In some embodiments, a natural rubber is a polymer derived predominantly from cis-1,4-polyisoprene and may range in grade from a light pale crepe grade to a darker ribbed smoked sheet. Examples of commercially available natural rubbers that may be useful as an elastomeric component of the presently disclosed adhesive compositions include those commercially available from Akrochem, Akron Ohio, under the trade designations “CLARIMER CV-60” (a controlled viscosity rubber grade) and “SMR-5” (a ribbed smoked sheet rubber grade). Natural rubbers may range in molecular weights from e.g. about 100,000 g/mol to about 1,000,000 g/mol. As mentioned above, due to their non-thermoplastic nature, many natural rubber grades may need to be masticated to reduce their molecular weight to facilitate e.g. hot-melt coating. This may be conventionally done by pre-processing e.g. in a Banbury mixer. Alternatively, U.S. Pat. No. 5539033 (Bredahl) describes a twin-screw extrusion compounding operation for processing natural rubber into a condition in which it can be incorporated into a hot-melt coatable adhesive composition.

In some embodiments, synthetic rubbers useful in the present disclosure can be chosen from butyl rubber, synthetic polyisoprene rubber, ethylene-propylene rubber, ethylene-propylene-diene rubber, polybutadiene rubber, polyisobutylene rubber, poly(alpha-olefin) rubber, nitrile rubber, and styrene-butadiene rubber, and may, if needed, be processed in the manner described above for natural rubber.

In some embodiments, the rubber elastomer mixture includes one or more block copolymers that include substantially only hydrogen and carbon atoms. In some embodiments, the hydrocarbon block copolymers include discrete blocks where one block is substantially free of content from another block. In some embodiments, the hydrocarbon block polymers include one or more blocks having measurable or even significant content attributable to another block; where the hydrocarbon block copolymers may be referred to as “blocky”. As used herein, the term “hydrocarbon block copolymers” includes both discrete block copolymers and blocky copolymers, unless otherwise specified.

In some embodiments, adhesive compositions useful in the presently disclosed binder layer or application layer include block copolymers that are styrenic block copolymers (SBCs). SBCs generally include copolymers of the A-B or A-B-A type and combinations thereof, where A represents a thermoplastic polystyrene block and B represents an elastomeric block, such as polyisoprene, polybutadiene, poly(ethylene/butylene), poly(ethylene/propylene), or poly(isoprene/butadiene). SBC molecular weights typically range from about 100,000 grams per mole to about 1,500,000 grams per mole.

Examples of useful styrene-based, or styrenic, block copolymers include styrene-isoprene block copolymers, styrene-ethylene block copolymers, styrene-propylene block copolymers, styrene-ethylene-propylene block copolymers, styrene-ethylene-butylene block copolymers, styrene-butadiene block copolymers, styrene-isoprene-butadiene-styrene block copolymers, and combinations thereof. In some embodiments, the styrene based block copolymers are diblock, triblock, or higher block copolymers. In some embodiments, the styrene-based block copolymer is a styrene-isoprene diblock copolymer, a styrene-isoprene-styrene triblock copolymer, and combinations and mixtures thereof. In some embodiments, functionalized (e.g., maleated) versions of any of the above block copolymers may be used. In some embodiments, the styrene block copolymers are styrenic block copolymers comprising styrenic end block and isoprene mid-block. In some embodiments, the styrenic block copolymers comprise diblock copolymers of a styrene block and an isoprene block.

SBCs useful in the present disclosure can be in the form of various molecular architectures including linear, branched, radial, star and tapered geometries. Variation of the volume fraction of styrene in the two-phase composition leads to polystyrene domains in the shape of spheroids, cylinders, plates and co-continuous structures. In some embodiments, weight percent of the styrene component in the one or more styrene block copolymers can range from about 5 weight percent (wt %) styrene to about 50 wt % styrene, in some embodiments from about 8 wt % styrene to about 40 wt % styrene, in some embodiments from about 15 wt % styrene to 35 wt % styrene, and some embodiments from about 20 wt % styrene to about 30 wt % styrene.

Non-limiting examples of commercially available SBCs useful in the presently disclosed binder layers or application layers include styrene-isoprene block copolymers, such as those commercially available under the trade designations “KRATON D1161”, “KRATON D1119”, and “KRATON D1117” from Kraton Performance Polymers, Inc. Houston, Texas; “VECTOR 4113”, and “VECTOR 4111A” from Dexco Polymers LLP, Taipei, Taiwan; “QUINTAC 3620” from Zeon Corp. Tokyo, Japan; and “EUROPRENE SOL T 9113” from Versalis (formerly Polimeri Europa S.p.A.), Milan, Italy. Non-limiting examples of commercially available SBCs useful in the presently disclosed pressure-sensitive adhesives (PSAs) also include styrene-ethylene/butylene block copolymers, such as those commercially available under the trade designation “KRATON G1657” from Kraton Performance Polymers, Inc.; styrene-ethylene/propylene block copolymers, such as those commercially available under the trade designation “KRATON G1702” from Kraton Performance Polymers, Inc.; styrene-butadiene block copolymers, such as those commercially available under the trade designation “KRATON D1118X” from Kraton Performance Polymers, Inc.; and styrene-isoprene/butadiene block copolymers, such as those commercially available under the trade designation “KRATOND1171P” from Kraton Performance Polymers, Inc.

In some embodiments, SBCs are modified by the addition of one or more non-polymeric compounds such as tackifiers and/or plasticizing oils to, for example, increase the tack. Any suitable tackifier that is particularly effective in combination with an SBC may be used in the binder or application layer adhesive. In some embodiments, the tackifier and the plasticizer may be used alone or in combination with one another. In some embodiments, the tackifier and the plasticizer may be combined with aforementioned tackifier containing non-carbon hetero-atom functionality individually or together.

In some embodiments, a non-styrenic hydrocarbon block copolymer or combination thereof can be used, either along with a styrenic block copolymer, or without any styrenic block copolymer being present. In some embodiments, the block copolymers may include, for example, isoprene-butadiene block copolymers, ethylene-butylene block copolymers, and ethylene-propylene block copolymers.

In some embodiments, the hydrocarbon block copolymer (e.g., styrenic block copolymer) may include a blend of two or more such copolymers. In some embodiments, the blends of block copolymers include blends of polymers differing solely in terms of overall molecular weight, molecular weight of one or more blocks, degree of branching, chemical makeup of blocks, number of blocks, or molecular weight of block fractions. In some embodiments, the blends of block copolymers have more than one such difference. In some embodiments, a blend of substantially linear triblock copolymer blended with a substantially linear block copolymer may be employed.

In some embodiments, adhesive compositions useful in the presently disclosed binder layer or application layer include at least one tackifier, optionally at least one tackifier containing non-carbon hetero-atom functionality, and at least one elastomer that is chosen from natural rubbers and synthetic rubbers and combinations thereof. In some embodiments, the adhesive composition may include a hydrocarbon block copolymer, e.g. a styrenic block copolymer, also as noted. Other components may also be present in adhesive compositions useful in the present disclosure and are discussed later herein.

As used herein, the term “tackifier” (e.g., a tackifying resin) means a material that is part of an adhesive as a rheological modifier to increase glass transition temperature, decrease modulus, increase tack, or a combination of two or more of these.

As used herein, the term “plasticizer” (e.g. a plasticizing oil) means a material that is part of an adhesive as a rheological modifier to lower viscosity, decrease glass transition temperature, decrease modulus, or a combination of two or more of these.

As used herein, the term “acid number” means the milligrams of potassium hydroxide (KOH) required to neutralize all hetero-atom functionalities present in 1 gram of a tackifier compound (mg KOH/g), where the hetero-atom functionalities comprise at least one of acidic functionalities, hydroxyl functionalities, and combinations thereof.

The present disclosure provides an adhesive having at least one tackifier containing non-carbon hetero-atom functionality, or tackifying resin, useful in the presently disclosed binder layer or application layer. In some embodiments, the tackifier contains non-carbon hetero-atom functionality, e.g. comprise at least one of acidic moiety, hydroxyl moiety, and combinations thereof. In some embodiments, the tackifier containing non-carbon hetero-atom functionality is characterized by an acid number of between 20 mg KOH/g and 130 mg KOH/g, in some cases between 20 mg KOH/g and 90 mg KOH/g, in some cases between 40 mg KOH/g and 80 mg KOH/g, in some case between 50 mg KOH/g and 70 mg KOH/g, and in some cases between 55 mg KOH/g and 65 mg KOH/g. The tackifier(s) containing non-carbon hetero-atom functionality, including a phenolic moiety, can have an acid number of less than 0.5 mg KOH/g, and in some cases less than 0.25 mg KOH/g.

In some embodiments, tackifiers useful in the present disclosure are characterized by a polarity index. In some embodiments, the polarity index of the tackifier is greater than or equal to about 2.5, or greater than or equal to about 3. In some embodiments, the polarity index of the tackifier is less than or equal to about 40, or less than or equal to about 10.5. In some embodiments, the polarity index of the tackifier is between about 2.5 and about 10.5. In some embodiments, the polarity index of the tackifiers is between about 4 and about 40. Polarity index as used herein can be calculated using the following formula:

$$Polarity Index = \sum 〚 acid number of tackifier A \times wt \% of tackifier A + acid number of tackifier B \times wt \% of tackifier B + … 〛$$

The phenolic moiety is an aromatic moiety having at least one hydroxyl group covalently bonded directly thereto; the simplest phenolic moiety is derived from the compound phenol (hydroxybenzene). In some embodiments, the phenolic moiety includes two or more aromatic rings bonded or fused together, either directly or through a linking group. In some embodiments, the phenolic moiety has two or more hydroxyl groups bonded thereto. In some embodiments, one or more additional substituents, such as alkyl groups, are present on the phenolic moiety. Blends of phenolic compounds are also suitably employed in the reactions leading to the terpene phenolic tackifiers useful in the adhesives described herein.

Phenolic compounds include polyhydroxylated benzenes. Useful polyhydroxylated benzene compounds include dihydroxybenzenes and trihydroxybenzenes. Dihydroxybenzene compounds useful in reactions herein can include, in some embodiments, hydroquinone (1,4-dihydroxybenzene), catechol (1,2-dihydroxybenzene), and resorcinol (1,3-dihydroxybenzene). Trihydroxybenzene compounds useful in reactions herein can include, in some embodiments, phloroglucinol (1,3,5-trihydroxybenzene), hydroxyhydroquinone (1,2,4-trihydroxybenzene), and pyrogallol (1,2,3-benzenetriol). In some embodiments, polyhydroxylated adducts of naphthalene are useful in the reactions herein; examples of such compounds include, in some embodiments, 1,2-dihydroxynaphthalene, 1,3-dihydroxynaphthalene, 1,6-dihydroxynaphthalene, 2,3-dihydroxynaphthalene, 2,7-dihydroxynaphthalene, and the like.

In some embodiments, hydroxylated and polyhydroxylated anthracene, phenanthrene, azulene, and the like are suitably employed in the reactions that form one or more terpene phenolics useful as tackifiers in the adhesive. Bisphenols, such as bisphenol A and other compounds having non-fused multiple aromatic rings bonded via a linking group are also useful. While not being bound by theory, it is believed that it is not necessary for each aromatic ring to have a hydroxyl group provided that at least one aromatic ring has at least one hydroxyl group present and bonded directly thereto.

Additionally, dimers, trimers, and oligomers of phenolic compounds and blends thereof are suitably employed in the reactions that form one or more terpene phenolics useful as tackifiers in the adhesive. Such compounds include, for example, dimerized or oligomerized phenolic compounds formed via condensation with an aldehyde to result in methylene or methylol ether linking groups. Such compounds are widely used in the industry as precursors or prepolymers for phenol-formaldehyde resins. In some embodiments, both novalac and resole type precursors can be useful; and, in some embodiments novalac precursors are preferred. In some embodiments the phenolic compound, or a blend of phenolic compounds, are pre-condensed or oligomerized. In somewhat more detail, a phenolic compound, or a combination of two or more phenolic compounds are combined with an amount of an aldehyde that is selected to provide the desired level of oligomerization, and an acidic or basic catalyst employed under conditions of mild heat, for example between 50° C. and 100° C., to obtain the condensation products thereof. The oligomers thus formed have multiple reaction sites that are useful in subsequent steps in the formation of the tackifiers useful in the adhesive compositions herein. In some embodiments, suitable phenolic oligomers include naturally occurring oligomeric structures, such as tannic acid, humic acid, fulvic acid, and Quebracho extracts.

In some embodiments, one or more additional substituents are present on one or more rings of the phenolic compounds. For example, one or more alkyl, ether, halogen, amino, amido, imino, carbonyl, or other substituents, or a combination of two or more thereof, may be present as substituents bonded to the aromatic ring(s) of the phenolic compounds, or present as a substituent on an alkyl or alkenyl group bonded to the aromatic ring(s) of the phenolic compounds. In many embodiments, however, the one or more additional substituents substantially exclude or completely exclude acidic or potentially acidic moieties. In some embodiments, tackifiers used in the adhesives are characterized by an acid number of less than about 0.5 mg KOH/g. In some embodiments, tackifiers used in the adhesives herein are characterized by an acid number of great than above 1 mg KOH/g.

In some embodiments, phenolic compounds having more than one hydroxyl group, more than one aromatic group, and one or more additional substituents are suitably employed in the reactions that form one or more tackifiers that are useful in the presently disclosed adhesives. Some examples of such compounds include 4,4′-[(1E)-pent-1-en-4-yne-1,5-diyl]di(benzene-1,2-diol), quercetin (2-(3,4-dihydroxyphenyl)-3,5,7-trihydroxychromen-4-one), myricetin (3,5,7-trihydroxy-2-(3,4,5-trihydroxyphenyl)chromen-4-one), theaflavin (1,8-bis(3-alpha,5,7-trihydroxy-2-alpha-chromanyl)-5H-benzocyclohepten-5-one) and gossypol (2,2′-Bis(formyl-1,6,7-trihydroxy-5-isopropyl-3-methylnaphthalene).

In some embodiments, blends of two or more of any of the phenolic compounds described herein are useful in various embodiments to form tackifiers useful in the presently disclosed adhesives. The use of any of the above, alone or in combination, is not particularly limited; rather, the selection and use thereof is suitably adjusted to result in the desired end product useful in one or more presently disclosed adhesive compositions.

As disclosed herein, nonpolar tackifiers include a compound or mixture of compounds that function as tackifiers in the presently disclosed adhesive compositions, where such compounds or mixtures of compounds are essentially free of polar groups. In some embodiments, the compounds or mixtures of compounds are free of polar groups. While not being bound by theory, it is believed that such nonpolar tackifiers have a softening point between about 100° C. and 135° C., and in some embodiments between about 110° C. and 120° C., and in some embodiments, are compatible in mixtures having styrene block copolymers.

Any suitable tackifier(s) with non-carbon hetero-atom functionality may be used in the present disclosure. Potentially suitable tackifiers resins may include (but are not limited to) e.g. tackifiers which include maleic anhydride modified rosin esters (commercially available under the trade designation “RESINALL” from Resinall Corp., Severn, North Carolina); phenolic tackifiers (commercially available under that trade designations “SP25” and “SP6700” from SI Group, Schenectady, New York); terpene phenol tackifiers (commercially available under the trade designation “T160” from Yasuhara Chemicals, Hiroshima, Japan). Maleic modified glycerol rosin esters and phenolic modified rosin esters, such as those commercially available under the trade designations “LEWISOL 28-M”, “LEWISOL 29-M”, “PENTALYN 702-M”, “PENTALYN 765-M”, “PENTALYN 750-HV-M”, “PENTALYN 770M”, and “PENTALYN 755-M” from Eastman Chemicals in Kingston, Tenn.

In some embodiments, the tackifier may be an aliphatic or aromatic material and, if multiple tackifiers are present, they may all be aliphatic or aromatic materials in some embodiments. In some embodiments, the tackifier or tackifiers may be a hydrocarbon material. In some embodiments, the tackifier or tackifiers are CS-derived aliphatic resins, which are obtained from unsaturated hydrocarbon feedstock containing primarily pentenes and piperylene. Potentially suitable CS-derived aliphatic resins include those commercially available from Eastman Chemical Co. under the trade designations “PICCOTAC 1020”, “PICCOTAC 1095”, “PICCOTAC 1098”, “PICCOTAC 1100”, and “PICCOTAC 1115”. In some embodiments, the tackifier or tackifiers are C9-derived aromatic resins, which are obtained from unsaturated hydrocarbon feedstock resin oil containing but not limited to indene, vinyltoluene, and dicyclopentadiene. Potentially suitable resins include those commercially available from Eastman Chemical under the trade designations “PICCO 2215”, “PICCO 5120”, “PICCO 5140”, and “PICCO 6100”. C5/C9-derived resins produced by mixing the two feedstocks together may also be used in the present disclosure, such as those commercially available from Eastman Chemical under the trade designations “PICCOTAC 8095”, “PICCOTAC 9095”, “PICCOTAC 7050”. In some embodiments, the adhesive composition includes at least one tackifier containing non-carbon hetero-atom functionality, at least one styrene block copolymer, and optionally at least one tackifier which is essentially free of non-carbon hetero-atom functionality. In some embodiments, the adhesive composition may optionally include a hydrocarbon block copolymer, e.g. a block copolymer based on styrene and isoprene.

In some embodiments, the adhesive composition includes a weight percent of tackifier containing non-carbon hetero-atom functionality in an amount greater than or equal to about 5 wt %, 10 wt %, 15 wt %, 20 wt %, 25 wt %, 30 wt %, 35 wt %, 40 wt %, 45 wt %, 50 wt %, 55 wt %, 60 wt %, or 65 wt %, based on the total weight of the adhesive composition. In some embodiments, the tackifier containing non-carbon hetero-atom functionality may be present in an amount less than or equal to about 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, or 70 wt %, based on the total weight of the adhesive composition.

All weight percentages and ratios of weight percentages used herein are based on the total weight of the components of the adhesive (as it is present on fabric or other backing), and specifically do not include the presence of any solvent or inert filler (e.g., a mineral filler such as calcium carbonate, titanium dioxide, talc, glass powder, silica and so on) that may be present. That is, for the purposes of all the compositional calculations and ranges disclosed herein, the presence of any mineral filler or solvent is not be included.

In some embodiments, the rubber elastomer combinations, such as, for example, the styrenic block copolymer combinations, are present in the adhesive composition in an amount greater than or equal to about 40 wt %, 45 wt %, 50 wt %, 55 wt %, 60 wt %, 65 wt %, 70 wt %, 75 wt %, 80 wt %, 85 wt %, 90 wt %, or 95 wt %, based on the total weight of the adhesive composition. In some embodiments, the styrenic block copolymer polymer may be present in an amount less than or equal to about 40 wt %, 45 wt %, 50 wt %, 55 wt %, 60 wt %, 65 wt %, 70 wt %, 75 wt %, 80 wt %, 85 wt %, 95 wt %, or 98 wt %, based on the total weight of the adhesive composition.

In some embodiments, a hydrocarbon block copolymer (e.g. a styrenic block copolymer) is present in the presently disclosed adhesive composition in an amount greater than or equal to about 10 wt %, 12 wt %, 14 wt %, or 16 wt %, based on the total weight of the adhesive composition. In some embodiments, the hydrocarbon block copolymer may be present in an amount less than or equal to about 35 wt %, 30 wt %, 24 wt %, 22 wt %, 20 wt %, or 18 wt %, based on the total weight of the adhesive composition. In some embodiments, a weight ratio of the hydrocarbon block copolymer to the total amount of tackifier(s) (both containing and not containing non-carbon hetero-atom functionalities) in the adhesive composition may be at least about 25:75, 30:70 or 35:65. In some embodiments, the weight ratio of the hydrocarbon block copolymer to the total amount of tackifier (both polar and nonpolar) in the adhesive composition may be at most about 50:50, 45:55, or 40:60.

In some embodiments, the adhesive composition may also include one or more additional components. For example, these additional components include, but are not limited to, anti-aging agents, light and ultraviolet stabilizers (such as e.g. a hindered amine light stabilizer), colorants, thermal stabilizers, anti-microbial agents, fillers, crosslinkers, and combinations thereof.

In some embodiments, the presently disclosed adhesive compositions include an anti-oxidant. While not intending to be bound by theory, it is believed that anti-oxidants can be useful to prevent oxidation reactions from affecting components of the adhesive compositions. Oxidation of components can lead to various negative effects in the adhesive compositions including, but not limited, to color changes, changes in molecular weight of polymeric components, rheological changes, changes in tack, changes to release properties, and the like. Anti-oxidants useful in the present disclose include various agents including, but not limited to, phenols (including but not limited to hindered phenolics and bisphenolics), mercaptan group containing compounds (including, but not limited to thioethers, thioesters, and mercapto-benzimidazoles), di-hydroquinolines, hydroquinones, lactates, butylated paracresols, amines, unsaturated acetals, fluorophosphonites, phosphites, and blends of these. It will be appreciated that these groups are not exclusive in some cases. By way of examples, a phenolic compound could also have a mercaptan group.

Examples of phenolic anti-oxidants useful in the present disclosure include, but are not limited to, those commercially available from BASF Corp., Florham Park, N.J., USA under the trade designations “IRGANOX 1010”, “IRGANOX 1035”, “IRGANOX 1076”, “IRGANOX 1098”, “IRGANOX 245”, “IRGANOX 3114”, and “IRGANOX 565”; those commercially available from the SI Group, Schenectady, N.Y. under the trade designations “ETHANOX 330”, “ETHANOX 702”, “ISONOX 129”, and “ISONOX 132”; those commercially available from Solvay S.A., Houston, Texas under the trade designations “CYANOX 425”, “CYANOX 2246”, and “CYANOX 1790”; those commercially available from the Addivant Corporation, Danbury, Conn. under the trade designations “ULTRANOX 276”, “NAUGARD BHT”, “NAUGARD 76”, “NAUGARD 10”, “NAUGARD SP”, and “NAUGARD 529”; those commercially available from Clariant International LTD., Muttenz, Switzerland under the trade designation “HOSTANOX 03”; and those commercially available from Imperial Chemical Industries, London, England under the trade designations “TOPANOL CA”, “TOPANOL CA-SF”, and “TOPANOL 205”. Examples of mercaptan group containing anti-oxidants useful in the present disclosure include, but are not limited to, those commercially available from BASF Corp., Florham Park, N.J., USA under the trade designations “IRGANOX 1726” and “IRGANOX 1520 L”.

Other mercaptan group containing anti-oxidants useful in the present disclosure include those in the form of thioether anti-oxidants, such as those commercially available from BASF Corp., Florham Park, N.J., USA under the trade designations “IRGANOX PS800” and “IRGANOX PS802”. Other mercaptan group containing anti-oxidants useful in the present disclosure, in the form of thioester anti-oxidants, include those commercially available from Solvay S.A., Houston, Tex. under the following trade designations “CYANOX LTDP”, “CYANOX STDP”, “CYANOX MTDP”, “CYANOX 1212”, and “CYANOX 711”.

Exemplary fluorophosphonite anti-oxidants useful in the present disclosure include those commercially available from SI Group, Schenectady, N.Y. under the trade designation “ETHANOX 398”. Examples of phosphite anti-oxidants useful in the present disclosure include those commercially available from Clariant International LTD., Muttenz, Switzerland under the trade designation “HOSTANOX PAR 24”; those commercially available from the Addivant Corporation, Danbury, Conn. under the trade designations “WESTON619”, “NAUGARD P” and “NAUGARD 524”; and those commercially available from BASF Corp., Florham Park, N.J., USA under the trade designations “IRGAFOS 126” and “IRGAFOS 168”. Additional exemplary anti-oxidants useful in the present disclosure include those commercially available from BASF Corp., Florham Park, N.J., USA under the trade designations

“IRGANOX 1330”, “IRGANOX 1425”, “IRGANOX 1425 WL”, “IRGANOX 245 DW”, “IRGANOX 5057”, “IRGANOX B 1171”, “IRGANOX B 215”, “IRGANOX B 225”, “IRGANOX B 501 W”, “IRGANOX B 900”, “IRGANOX E 201”, “IRGANOX L 06”, “IRGANOX L 101”, “IRGANOX L 107”, “IRGANOX L 109”, “IRGANOX L 1 15”, “IRGANOX L 118”, “IRGANOX L 135”, “IRGANOX L 150”, “IRGANOX L 55”,

“IRGANOX L 57”, “IRGANOX L 64”, “IRGANOX L 67”, “IRGANOX L 74”, “IRGANOX MD-1024”, “IRGANOX ML-811”, “IRGANOX ML-820”, “IRGANOX ML-840”, “IRGANOX PS 802 FL”, “IRGANOX XT 500” and “IRGASTAB FS 042”.

In some embodiments, the anti-oxidant decomposes hydroxyl or hydroperoxide groups in the adhesive composition. In some embodiments, the anti-oxidant decomposes hydroxyl and hydroperoxide groups in the adhesive composition. In some embodiments, the amount of the anti-oxidant used is greater than about 0 wt %, 0.01 wt %, 0.05 wt %, 0.10 wt %, 0.20 wt %, 0.30 wt %, 0.40 wt %, 0.50 wt %, 1.00 wt %, 1.50 wt %, or greater than 2.00 wt % based on the total weight of the adhesive composition. In some embodiments, the amount of the anti-oxidant used is less than about 5.00 wt %, 4.00 wt %, 3.00 wt %, 2.50 wt %, 2.00 wt %, 1.50 wt %, or 1.00 wt %, 0.80 wt %, or 0.50 wt % based on the total weight of the adhesive composition. In some embodiments, the amount of the anti-oxidant used can be in a range where any of the preceding numbers can form the lower bound or higher bound of the range, and where the higher bound is higher than the lower bound. For example, in some embodiments, the amount of the anti-oxidant can be in a range of about 0 wt % to about 2.00 wt % based on the total weight of the adhesive composition. In some embodiments, the adhesive composition also includes at least 0.1 wt % of an anti-oxidant, based on the total weight of the adhesive composition.

In some embodiments, the presently disclosed adhesive composition includes between about 70 wt % and about 81.5 wt % of at least one styrenic block copolymer, between about 8 wt % and about 30 wt % of a tackifier having an acid number greater than or equal to 1 mg KOH/g, and about 1 wt % of an anti-oxidant, where weight percentages are based on the total weight of the adhesive composition. One of the preferred composition embodiments is: 86 wt % of styrenic block copolymer, 13 wt % of a tackifier, and 1 wt % of anti-oxidant.

In some embodiments, the adhesive composition is disposed, such as, for example, coated, on at least a portion of one major surface of a substrate. In some embodiments, the adhesive composition may be disposed on a major surface of the substrate by disposing an adhesive precursor on the major surface and then transforming the precursor into the adhesive composition. In some embodiments, this may be performed by way of the precursor being a solvent mixture that is coated on the major surface, followed by removal of the solvent so that the remaining material is the adhesive. In some embodiments, the adhesive precursor may be cured, crosslinked, or the like as an additional step to solvent removal or in lieu of solvent removal.

In some embodiments, the adhesive composition is disposed onto the substrate using a solventless process, such as, for example, a hot-melt coating process (such as, for example, in a twin-screw extruder, in a general manner described in U.S. Reissue Pat. No. RE36855 (Bredahl)), in which the adhesive precursor is coated onto the substrate while at an elevated temperature and, after being coated or deposited, is cooled and transformed into the adhesive composition. In some embodiments, these processes may be facilitated by curing, such as, for example, by crosslinking various components of the adhesive precursor or the entire adhesive precursor, by using, for example, the application of an energy source, such as exposure to heat or a radiation source, such as actinic radiation (e.g., ultra-violet light, light from a light-emitting diode also known as LED light, and the like) and electron beam radiation.

In some embodiments, a continuous process may be used in which a rubber elastomer component of the adhesive precursor is processed (such as, for example, in a twin-screw extruder), and combined with other components of the adhesive precursor, in a general manner described in U.S. Reissue Pat. No. RE36855 (Bredahl), which is incorporated by reference in its entirety herein. The thickness of the resulting adhesive composition may be any desired value, such as ranging from about 1 micron to about 200 microns.

In some embodiments, the presently disclosed adhesive composition is a hot-melt coated adhesive. Such a hot-melt coated adhesive may be distinguished from adhesives prepared by other methods (such as, for example, solvent coating, and the like) by way of specific compositional indicators left behind in the resulting adhesive, such as, for example, the presence or absence of solvent residue, or other known indicators.

### EXAMPLES

Objects and advantages may be further illustrated by the following examples, but the particular materials and amounts thereof recited in these examples, as well as other conditions and details, should not be construed to unduly limit this disclosure.

| Abbre- | | |
|---|---|---|
| viation | | Acid |
| or Trade | | Number |
| Desig- | | (mg KOH/ |
| nations | Description | g resin) |
| D1119 | Copolymer based on styrene and isoprene with a | n/a |
| | styrene content of 22%, commercially available as | |
| | Kraton D1119 from Kraton Corporation, | |
| | Houston, Texas | |
| Irganox | A multifunctional phenolic anti-oxidant containing | n/a |
| 1520L | 4,6-bis (octylthiomethyl)-o-cresol, commercially | |
| | available as Irganox 1520L from BASF, | |
| | New Jersey | |
| K100 | Aliphatic piperylene based tackifier, commercially | <0.1 |
| | available as Quintone K100 from Zeon Chemical, | |
| | Louisville, Kentucky | |
| SP25 | Mixed alkylphenols novolac resin based tackifier, | 25-42* |
| | commercially available as SP25 from SI Group, | |
| | Schenectady, New York | |
| SP1077 | Epoxy modified phenolic novalac resin based | 25-42* |
| | tackifier, commercially available as SP1077 | |
| | from SI Group, Schenectady, New York | |
| Unitac- | Modified rosin resin based tackifier, commercially | 145-160* |
| 70 | available as Uni-tac 70 from Kraton Corporation, | |
| | Houston, Texas | |
| Resinall | Rosin ester with medium dibasic acid levels | 41* |
| 476 | based tackifier, commercially available as Resinall | |
| | 476 from Resinall Corp, Severn, North Carolina | |
| Resinall | Rosin-modified maleic resin based tackifier, | 43* |
| 477 | commercially available as Resinall 477 from | |
| | Resinall Corp, Severn, North Carolina | |
| Resinall | Rosin-modified maleic resin based tackifier, | 191* |
| 224 | commercially available as Resinall 224 from | |
| | Resinall Corp, Severn, North Carolina | |
| Resinall | Rosin-modified maleic resin based tackifier, | 205* |
| 830 | commercially available as Resinall 830 from | |
| | Resinall Corp, Severn, North Carolina | |
| Westrez | Maleated glycerol ester resin based tackifier, | 35* |
| 5206 | commercially available as Westerz 5206 from | |
| | Ingevity, North Charleston, South Carolina | |
| T160 | YS Polyster terpene phenol resin based tackifier, | 55-70* |
| | commercially available as T160 from Yasuhara | |
| | Chemicals, Hiroshima, Japan | |
| Foral 85 | Ester of hydrogenated wood resin based tackifier, | 3-10* |
| | commercially available as Foral 85 from Pinova, | |
| | Brunswick, Georgia | |
| Foral | Pentaerythritol ester of highly hydrogenated | 7-16* |
| 105 | refined wood resin based tackifier, commercially | |
| | available as Foral 105 from Pinova, | |
| | Brunswick, Georgia | |
| Stearic | A saturated fatty acid with an 18-carbon chain | n/a |
| Acid | and has the IUPAC name octadecanoic acid, | |
| | commercially available as stearic acid from TCI | |
| | Chemicals, Tokyo, Japan | |
| Silvet | Automotive quality medium particle size | |
| Al | aluminum pigment pellet with silver dollar | |
| Flakes | geometry, commercially available as Sparkle | n/a |
| | Silvet Premier 860-20-P from Silberline | |
| | Manufacturing Co., Inc., Tamaqua, Pennsylvania | |
| C420 | Scotchlite C420 silver footwear film, | n/a |
| film | commercially available from 3M Company, | |
| | St. Paul, MN, construction in FIG. 2. | |
| PET | 100% polyester fabric commercially available | n/a |
| Fabric | from Milliken & Company, | |
| | Spartanburg, South Carolina | |

*for calculation of polarity index, the value used is the average of the high and low values

### Synthesis Example S1

A temporary glass bead carrier was prepared in a procedure as described in U.S. Pat. No. 5,474,827 (Crandall). A poly-ethylene layer was coated on a paper backing. The polyethylene layer was heated, and glass beads with average diameter in the range of 40-90 micrometers were cascaded and sunk into the polyethylene layer. The depth at which the glass beads were sunk was smaller than the average diameter of the glass beads, and a portion of the microspheres remained exposed above the surface of the polyethylene. The coated glass bead layers were vapor coated with a thin layer of aluminum metal to form an aluminum metal mirror layer.

### Example 1

86 wt % of a copolymer (D1119) and 13 wt % of a tackifier (SP25) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 millimeter (mm) in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 2

86 wt % of a copolymer (D1119) and 13 wt % of a tackifier (SP1077) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness PET fabric. Then, a sheet of the vapor coated glass bead layer from Synthesis

Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 3

86 wt % of a copolymer (D1119) and 13 wt % of a tackifier (T160) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 4

69 wt % of a copolymer (D1119) and 30 wt % of a tackifier (SP25) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 5

69 wt % of a copolymer (D1119) and 30 wt % of a tackifier (Resinall 476) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 6

84 wt % of a copolymer (D1119) and 15 wt % of a tackifier (Resinall 476) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 7

54 wt % of a copolymer (D1119) and 45 wt % of a tackifier (Resinall 476) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 8

69 wt % of a copolymer (D1119) and 30 wt % of a tackifier (Resinall 477) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 9

84 wt % of a copolymer (D1119) and 15 wt % of a tackifier (SP25) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 10

84 wt % of a copolymer (D1119) and 15 wt % of a tackifier (Resinall 830) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 11

69 wt % of a copolymer (D1119) and 30 wt % of a tackifier (T160) were loaded into a twin-screw extruder as pellets, along with 1 wt % of an antioxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 12

67.5 wt % of a copolymer (D1119), 30 wt % of a tackifier (Westrez 5206), 1 wt % stearic acid, and 1.5 wt % Silvet A1 Flakes were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example 13

70 wt % of a copolymer (D1119) and 30 wt % of a tackifier (Resinall 476) were loaded into a twin-screw extruder as pellets, and allowed to mix in the extruder at 182° C. (360° F.) for 3 minutes. The mixed formulation was then extruded with a drop die at approximately 0.076 millimeter in coating thickness in between the PET fabric and the glass bead layer from Synthesis Example S1 with a roll nip pressure of approximately 344,738 Newtons per square meter (50 psi). Prior to testing, the carrier liner was stripped away, exposing the previously embedded surface of monolayer of glass microspheres to produce a retroreflective article.

### Example 14

86 wt % of a copolymer (D1119) and 13 wt % of a tackifier (SP25) were loaded into a twin-screw extruder as pellets, along with 1 wt % of an anti-oxidant (Irganox 1520L), delivered with a pipette, and allowed to mix in the extruder at about 182° C. (360° F.) for 3 minutes. The mixed formulation was then extruded onto C420 film with a contact die at approximately 0.076 millimeter in coating thickness. Prior to testing, the carrier liner of the C420 film was stripped away, exposing the previously embedded surface of monolayer of glass microspheres to produce a retroreflective article.

### Example C1

86 wt % of a copolymer (D1119) and 13 wt % of a tackifier (K100) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example C2

69 wt % of a copolymer (D1119) and 30 wt % of a tackifier (Foral 85) were loaded into a twin-screw extruder as pellets, along with 1 wt % of anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness onto PET fabric. Then, a sheet of the vapor coated glass bead layer from

Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example C3

69 wt % of a copolymer (D1119) and 30 wt % of a tackifier (Foral 105) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example C4

69 wt % of a copolymer (D1119) and 30 wt % of a tackifier (Unitac-70) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

### Example C5

69 wt % of a copolymer (D1119) and 30 wt % of a tackifier (Resinall 224) were loaded into a twin-screw extruder as pellets, along with 1 wt % of an anti-oxidant (Irganox 1520L), which was delivered with a pipette, and allowed to mix in the extruder at 182° C. (360° F.) for 3 minutes. The mixed formulation was then extruded onto with a contact die at approximately 0.076 mm in coating thickness onto PET fabric. Then, a sheet of the vapor coated glass bead layer from Synthesis Example S1 was hot laminated onto the adhesive using a Hix N-800 clamshell laminated at pressure of 206,843 Newtons per square meter (30 psi) and 135° C. (275° F.) for 10 seconds. Prior to testing, the carrier liner was stripped away, exposing the previously embedded surface of monolayer of glass microspheres to produce a retroreflective article.

Polarity index calculation:

Polarity index for each sample was calculated as:

$$Polarity Index = \sum acid number of tackifier A \times wt \% of tackifier A + acid number of tackifier B \times wt \% of tackifier B + …$$

Wash durability test:

Test samples of the articles of Examples 1 to 14 and Comparative Examples C1 to C5 were prepared by sewing appliques of the fabric articles onto a piece of polyester/cotton 85/15 fluorescent orange fabric having a weight of 270 grams per meter squared. The samples were then washed according to Method 6N of ISO 6330 for 10 cycles. Ra values were measured using the Retro-Meter 2 Retroreflectometer, at a 5° entrance angle and 0.2° observation angle, and reported in units of candelas per lux per square meter (candelas/lux/meter²). Examples 1 to 14 show higher retroreflectivity retention than Comparative Examples C1 to C5. A sample is deemed as “wash durable” if the percent retention of retroreflectivity after 10 cycles of wash according to Method 6N of ISO 6330 is greater than or equal to 10%.

TABLE 1

| | | | | | | | | Retroreflectivity | |
|---|---|---|---|---|---|---|---|---|---|
| | | Tackifier | | Anti- | Tackifier | | Initial | after 10 | Percent |
| | D1119 | Loading | Tackifier | oxidant | Acid | Polarity | Retroreflectivity | Wash Cycles | Retention |
| Example | Loading | (wt %) | Used | Loading | Number* | Index | (cd/lx/m\hat{ }2) | (cd/lx/m\hat{ }2) | (%) |
| 1 | 86.0% | 13.0% | SP25 | 1.0% | 25-42 | 4.4 | 463 | 213 | 46.0 |
| 2 | 86.0% | 13.0% | SP1077 | 1.0% | 25-42 | 4.4 | 460 | 224 | 48.7 |
| 3 | 86.0% | 13.0% | T160 | 1.0% | 55-70 | 8.1 | 465 | 148 | 31.9 |
| 4 | 69.0% | 30.0% | SP25 | 1.0% | 25-42 | 10.1 | 503 | 120 | 23.9 |
| 5 | 69.0% | 30.0% | Resinall 476 | 1.0% | 41 | 12.3 | 484 | 274 | 56.5 |
| 6 | 84.0% | 15.0% | Resinall 476 | 1.0% | 41 | 6.2 | 488 | 322 | 65.9 |
| 7 | 54.0% | 45.0% | Resinall 476 | 1.0% | 41 | 18.5 | 491 | 323 | 65.7 |
| 8 | 69.0% | 30.0% | Resinall 477 | 1.0% | 43 | 12.3 | 490 | 310 | 63.3 |
| 9 | 84.0% | 15.0% | SP25 | 1.0% | 25-42 | 5.0 | 405 | 79 | 19.6 |
| 10 | 84.0% | 15.0% | Resinall 830 | 1.0% | 205 | 30.8 | 415 | 260 | 62.7 |
| 11 | 69.0% | 30.0% | T160 | 1.0% | 55-70 | 18.8 | 471 | 323 | 68.7 |
| 12 | 67.5% | 30.0% | Westrez 5206 | 1.0% | 35 | 10.5 | 513 | 346 | 67.5 |
| 13 | 70.0% | 30.0% | Resinall 476 | 0% | 41 | 12.3 | 520 | 378 | 72.7 |
| 14 | 86.0% | 13.0% | SP25 | 1.0% | 25-42 | 4.4 | 525 | 446 | 85 |
| C1 | 86.0% | 13.0% | K100 | 1.0% | <0.1 | 0.0 | 459 | 14 | 3.1 |
| C2 | 69.0% | 30.0% | Foral 105 | 1.0% | 7-16 | 3.4 | 447 | 0 | 0.0 |
| C3 | 69.0% | 30.0% | Foral 85 | 1.0% | 3-10 | 2.0 | 460 | 0 | 0.0 |
| C4 | 69.0% | 30.0% | Unitac-70 | 1.0% | 145-160 | 45.8 | 462 | 0 | 0.0 |
| C5 | 69.0% | 30.0% | Resinall 224 | 1.0% | 191 | 57.3 | 495 | 0 | 0.0 |

1. A retroreflective article comprising:
a binder layer comprising an adhesive composition comprising at least one tackifier and at least one elastomer selected from at least one of natural rubbers and synthetic rubbers; and
a layer of optical elements at least partially embedded in a major surface of the binder layer.

2. The retroreflective article of claim 1, wherein the at least one elastomer is a styrenic block copolymer.

3. The retroreflective article of claim 2, wherein the styrenic block copolymer comprises styrene end block and isoprene mid-block.

4. The retroreflective article of claim 2, wherein the styrenic block copolymer comprises diblock copolymers of a styrene block and an isoprene block.

5. The retroreflective article of claim 1, wherein the at least one tackifier comprises non-carbon hetero-atom functionality.

6. The retroreflective article of claim 5, wherein the at least one tackifier has an acid number greater than or equal to 1 mg KOH/g.

7. The retroreflective article of claim 5, wherein the polarity index of the tackifiers is between 4 and 40.

8. The retroreflective article of claim 5, wherein the at least one tackifier comprises a carboxylic acid functional group.

9. The retroreflective article of claim 5, wherein the at least one tackifier is derived from a maleic anhydride.

10. The retroreflective article of claim 5, wherein the at least one tackifier is derived from a non-reactive novolac phenolic compound.

11. The retroreflective article of claim 1, wherein the at least one tackifier is present in an amount of greater than or equal to 5 wt %, based on the total weigh of the adhesive composition.

12. The retroreflective article of claim 1, wherein the at least one elastomer is present in an amount greater than or equal to 30 wt %, based on the total weight of the adhesive composition.

13. The retroreflective article of claim 1, wherein the adhesive composition further comprises a colorant or a filler.

14. The retroreflective article of claim 1, wherein the retroreflective article is wash durable.

15. The retroreflective article of claim 1, further comprising an application layer disposed on a major surface of the binder layer opposite the major surface in which the layer of optical elements is at least partially embedded.

16. The retroreflective article of claim 15, wherein the application layer comprises a layer of an adhesive, a film, a fabric, or a non-woven.

17. An article of clothing comprising:
a substrate layer comprising a fabric, wherein the substrate layer has a first major surface and a second major surface; and
a retroreflective applique disposed on the first major surface of the substrate layer, wherein the retroreflective applique comprises:
a binder layer comprising an adhesive composition comprising at least one tackifier and at least one elastomer selected from at least one of nature rubbers and synthetic rubbers; and
(ii) a layer of optical elements at least partially embedded in the binder layer.

18. The article of claim 17, further comprising an application layer attached to the binder layer, wherein the application layer comprises a layer of at least one of an adhesive, a film, a fabric, or a non-woven, and wherein the application layer is the layer in the retroreflective applique that is disposed on the first major surface of the fabric.

19. A method of preparing a retroreflective article comprising:
(a) providing a binder layer comprising an adhesive composition, wherein the adhesive composition comprises:
(i) at least one elastomer selected from at least one of natural rubbers and synthetic rubbers; and
(ii) at least one tackifier; and
(b) disposing the binder layer on portions of protruding areas of at least some optical elements that are borne by a carrier layer, wherein the optical elements are at least partially embedded in the binder layer.

20. The method of claim 19, further comprising attaching an application layer to a major surface of the binder layer opposite the optical elements, wherein the application layer comprises at least one of an adhesive layer, a film layer, a fabric layer, or a non-woven layer, or combinations thereof
